(19) United States
(12) Patent Application Publication
(10) Pub. No.: US 2018/0010078 A1
(43) Pub. Date: Jan. 11, 2018

(54) Detergent composition for treating fabrics with insecticides

(71) Applicant: Desayo O. Ajisegiri, Union City, NJ (US)

(72) Inventor: Desayo O. Ajisegiri, Union City, NJ (US)

(21) Appl. No.: 14/999,847

(22) Filed: Jul. 11, 2016

(51) Int. Cl. C11D 3/48; C11D 9/28; C11D 3/382; C11D 11/00; C11D 3/24

(52) U.S. Cl. CPC C11D 3/48; C11D 11/0017; C11D 3/24; C11D 3/382; C11D 9/28

(57) ABSTRACT

A detergent composition including permethrin is disclosed that is particularly adapted to launder clothing or other personal fabrics. Laundering clothing with composition provides effective insect repellant properties to the clothing for at least 14 days. The detergent composition is especially useful for control of mosquitoes and other insects, thereby reducing the incidence of malaria, zika virus, and other diseases.

### CROSS REFERENCE TO RELATED APPLICATIONS

This application is a continuation-in-part of U.S. patent application Ser. No. 14/121,795, filed Oct. 20, 2014, which disclosure is expressly incorporated by reference. The benefit of the Oct. 20, 2014 filing date is claimed pursuant to 35 U.S.C. §120 for all subject matter in common.

### STATEMENT REGARDING FEDERALLY SPONSORED RESEARCH OR DEVELOPMENT

Not Applicable

### THE NAMES OF PARTIES TO A JOINT RESEARCH AGREEMENT

None

### INCORPORATION-BY-REFERENCE OF MATERIAL SUBMITTED ON A COMPACT DISK

None

### BACKGROUND OF THE INVENTION

Malaria is a major cause of child mortality in much of Africa. The mosquito parasite, Plasmodium falciparum, accounts for greater than 25% of childhood mortality outside the neonatal period. In parts of Africa, malaria has been ranked first by the World Bank in terms of disability-adjusted life-years lost. Drug and insecticide resistance, as well as insufficiently developed and financed health services, have hampered efforts over the past twenty years to improve the situation. As a result, the malaria burden has remained largely unchanged.

Mortality in young children due to mosquito-borne malaria poses a significant world health problem. Insecticide-treated nets and fabrics have been developed since the 1980s as a promising tool for the prevention of malaria in endemic countries. Potent and safe synthetic pyrethroids, such as, permethrin, deltamethrin, lambda-cyhalothrin, alphamethrin, and cyfluthrin, are presently used to treat bednets and curtains by simply dipping the fabric into a solution containing the insecticide and allowing the solution to dry on the fabric. Provided that the nets or fabrics are not washed more than once to twice, insecticidal activity is retained for up to twelve months.

Many studies documenting the efficacy of these nets or fabrics to reduce the number of outbreaks of malaria in endemic areas have been conducted in several countries. Recently, the World Health Organization (WHO), along with twenty other donor agencies, supported four large-scale trials in Africa to document the impact of treated bednets on child survival. The results indicated that the reduction in child mortality with the use of treated nets ranged from 16-33%. Treated nets, in combination with the use of insect repellents, have been suggested as a primary means of protection for high-risk travelers. Although little evidence is presently available to document the efficacy of treated nets or fabrics for travelers at high risk, the available evidence is so compelling that specific recommendations are often issued to all travelers exposed to situations that place them at risk for malaria.

Bednets treated with insecticides have been effective in the control of malaria in many countries. The treated bednets are an effective method of vector control in areas endemic for malaria and greatly enhance personal protection. Although there is some concern that the placement of the insecticide-treated fabric in close proximity to the skin, eyes, or mouth of the person being protected may be harmful, existing toxicology data on pyrethroids indicates that unlike other types of insecticides, these chemicals have been shown to be very safe.

The application of a residual insecticide to fabrics as a means of personal protection against vector-borne diseases has been attempted for some time. During World War II, the impregnation of bednets and combat fatigues by the Soviet, German, and U.S. armies was first tried. In the late 1970s pyrethroids were used for this purpose; their high insecticidal activity combined with low mammalian toxicity made them ideal for treating fabrics. A scientific panel convened in 1983 by WHO reviewed the first laboratory evidence and recommended the initiation of field trials to assess the potential of this technology for disease control.

Unfortunately, currently employed techniques for treating fabrics with insecticides are unable to maintain an effective level of active ingredient at the surface of the net or fabric to kill or repel mosquitoes, especially after repeated washings. In addition, currently available methods for applying insecticides to fabrics are expensive, which make their use impractical for underdeveloped countries. Further, the available techniques utilize emulsions that vary greatly between manufacturers and do not provide consistent and effective results.

Further, there is a need for fabrics treated with insecticides to repel other disease carrying vectors, such as ticks, which carry a myriad of diseases including Rocky Mountain spotted fever and Lyme disease. The Lone Star tick has recently been linked to the transmission of allergies that cause a reaction the consumption of mammalian meat, including beef, lamb, pork or potentially the consumption of any mammal. There exists a need for a fabric conditioner that will repel not only mosquitoes, but also disease carrying vectors such as ticks.

### BRIEF SUMMARY OF THE INVENTION

The invention is a novel detergent for treating fabrics that kills insects on contact and protects the user from insect bites. The composition contains a unique active ingredient, Permethrin, which is a known insecticide. Permethrin, or (3-phenoxyphenyl)methyl 3-(2,2-dichloroethenyl)-2,2 dimethylcyclopropane carboxylate, is a common synthetic, and widely used insecticide and/or insect repellant. Permethrin is a type I pyrethroid (i.e., it lacks a cyano group at the α carbon position of the alcohol moiety) with the primary target organ being the nervous system of insects which then causes muscle spasms, paralysis and death. It is a synthetic molecule similar to pyrethrum, extracted from the Chrysanthemum flower.

Permethrin is odorless when dry, and will not stain or damage clothing, fabrics, plastics, finished surfaces, or other outdoor gear. It is skin friendly and not harmful to human life. It is safe, long lasting and effective as proven the U.S. Army Research Institute. The World Health Organization recommends Permethrin for the control of insects such as mosquitoes and cockroaches; it is also USDA (United States Department of Agriculture) approved and US military certified. It is used for pest control in offices, warehouses, hospitals, food processing factories, dairy operations, and other industrial/commercial buildings. Permethrin has been in use by the US and Canadian military to treat their uniform for over 30 years. It is contemplated to add Permethrin to cleaning agents (both liquid and otherwise) such as bathroom cleaners, surface cleaners etc.

### BRIEF DESCRIPTION OF THE INVENTION

A liquid solution comprising permethrin is infused into various cleaning products with the purpose to prepare detergent compositions used to treat and/or fortify fabric and other surfaces. Particular cleaning products which the permethrin/detergent compositions of the invention are combined with include but are not limited to, dry laundry detergent, laundry bar soap, and liquid laundry soap or detergent.

To formulate the liquid permethrin solution, 0.21 ounce of 36.8% liquid permethrin concentrate is added to 2 ounces of liquid detergent, which is added to 1 gallon of water. This permethrin solution is then infused into other cleaning products with the purpose to treat and/or fortify surfaces/items.

It is anticipated to combine the liquid permethrin solution of the invention with multipurpose cleaners such as floor cleaners, wall cleaners, and wood cleaners to treat various surfaces with permethrin.

Further, the liquid permethrin solution of the invention may be combined with laundry additives such as fabric softeners, starch, including spray starch, bleach, and other fabric and or laundry additives.

These products are combined with permethrin by mixing of 0.21 ounce of 36.8% permethrin concentrate per 1 gallon of the liquid cleaner or the liquid laundry soap.

### BRIEF DESCRIPTION OF THE DRAWINGS

FIG. 1 shows FTIR spectra of permethrin loaded detergent. Part (a) shows detergent containing no permethrin vs. detergent loaded with permethrin according to the invention at room temperature. Part (b) shows an FTIR spectra of detergent containing no permethrin vs. detergent loaded with permethrin according to the invention at 150° C.

FIG. 2 shows a depiction of a transmission high vacuum cell with wafer in the (a) front view (b) side view which was used to measure FTIR spectra of fabrics treated according to the invention.

FIG. 3 shows the kinetics of permethrin depletion on cloth after treatment. Part (a) shows IR Spectra of cloth washed with detergent containing no permethrin and detergent including permethrin according to the invention. Part (b) shows an integrated peak area vs. time. Part (c) extrapolates part of (b).

### DETAILED DESCRIPTION OF THE INVENTION

A dry impregnation process has been found to produce very good results, although it is expressly understood that the invention is not to be limited to the dry impregnation process.

The novel detergent composition of the invention is prepared at room temperature under reduced pressure by dry impregnation of detergent support with a 36.8 vol % aqueous solution of permethrin in a rotary evaporator with an aspirator. Dry impregnation is a common technique used in catalysis in which a metal-containing solution is added to a catalyst support containing the same pore volume as the volume of the solution that was added. Capillary action draws the solution into the pores. Solution added in excess of the support pore volume causes the solution transport to change from a capillary action process to a diffusion process, which is much slower and wets the support in excess. Dry impregnation was particularly adopted here to avoid extra wetting of the detergent. To determine the pore volume of the detergent, Nitrogen Physisorption followed by BET calculations are carried out. A pore volume of 0.26 ml/g was established for the detergent support used herein.

After the pore volume of the detergent support being used has been determined, the following procedure is followed:
A sample of dry detergent is collected in an agitator at room temperature (Agitation is adjusted based on the sample size to eliminate the mass transfer limitation).
A volume of permethrin solution equal the pore volume of the sample of detergent collected is then added dropwise to the detergent at 1 drop/second.
The sample is left in the agitator for 15-20 minutes to allow for thorough mixing.
The detergent mixture is then placed in the oven to dry for 20 minutes at 100° C. (A rotary evaporator can also be used in this step and it is in fact the preferred technique). Reduced pressure may be used when drying the detergent composition of the invention.
A preferred ester combination would be added as per discretion at production to give the detergent a suitable smell.

To use the novel composition, the user merely has to wash his/her clothes as usual with the insecticidal composition and dry them. The cloths immediately become insect repellent and kill insects on contact for a time period before the substance wears out. The clothes or bed netting can be washed by hand using the insecticidal composition, or the composition can used in the manner of a conventional laundry detergent, in a normal washing machine.

A preferred embodiment for forming a liquid composition to which the invention is not limited comprises mixing 0.21 ounces of 36.8% permethrin solution with 2 ounces of liquid detergent and 1 gallon of water.

A preferred embodiment for forming a dry composition to which the invention is not limited, comprises mixing 0.21 ounces of permethrin 36.8% liquid concentrate to per 100 grams of dry detergent then adding the permethrin/dry detergent composition to 1 gallon of water, and drying the composition under reduced pressure.

Additives: Mix permethrin with odorant (vanilla extract) before impregnation in a 1:1 mole ratio. Suitable additives include oil of lemon, oil of eucalyptus, and oil of citronella, or combinations thereof. Eucalyptus Globulus, also known as Blue Gum is a particularly preferred source of eucalyptus oil.

To make the dry composition 0.21 ounces of liquid 36.8% permethrin concentrate is added to 100 grams of dry detergent. This mixture is then added to 1 gallon of water.

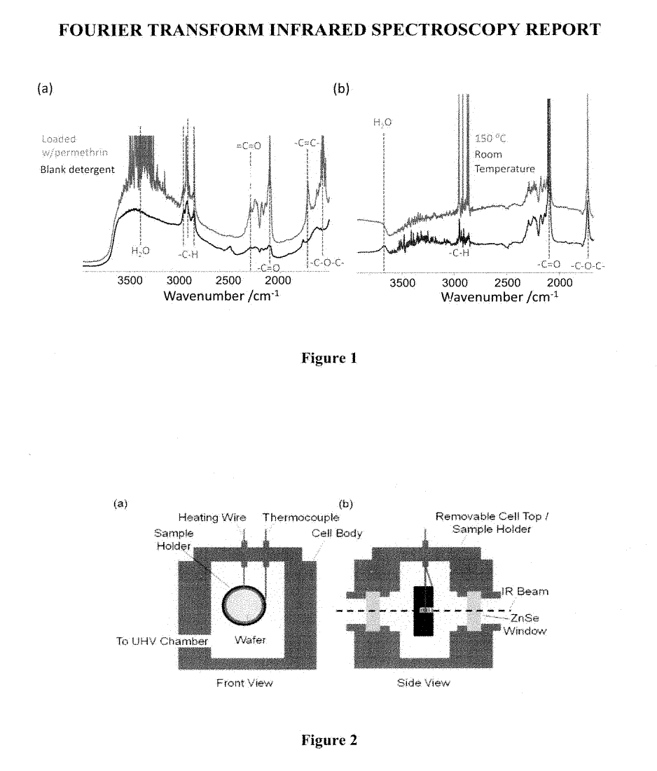

Referring to FIG. 1, an FTIR spectra of permethrin loaded detergent is shown. Part (a) represents a detergent with no permethrin vs. detergent loaded with permethrin at room temperature. Part (b) shows the FTIR spectra of a detergent with no permethrin vs. detergent loaded with permethrin at 150° C.

In order to understand the stability of permethrin on detergent, in situ IR spectroscopic studies were employed to elucidate surface interactions. The IR spectroscopic studies were undertaken using a high vacuum transmission cell. The results are seen in FIG. 1. Detergent with no permethrin and detergent loaded with permethrin were individually pressed into a translucent self-supported wafer and spectra were taken in a high vacuum. Monitoring the characteristics bands for permethrin provided a clear picture of the surface stability of permethrin on detergent.

IR studies were chosen for this analysis because IR peak assignment characteristics of a permethrin molecule has been extensively studied and reported in the literature. The broad band around 3500 cm⁻¹ is assigned to physisorbed water molecules on the detergent. Peaks around 2950 and 2870 cm⁻¹ are indicative of asymmetric and symmetric C—H stretching respectively which are common bands found in detergent and enhanced by permethrin. Bands below 2500 cm⁻¹ are assigned to different stretching vibrations within a permethrin molecule as shown in FIG. 1.

FIG. 1(a) shows the IR spectra of a blank detergent sample, or sample with no permethrin, and a sample loaded with permethrin. As observed from the IR spectra, new bands below 2500 cm⁻¹ were seen on the samples loaded with permethrin. These bands are representative of vibrations within a permethrin molecule. This indicates that permethrin is very well stabilized within the pores of detergent and no surface reaction or degradation of permethrin is promoted by the detergent. In FIG. 1 (b), an IR spectra of detergent without permethrin vs. permethrin on detergent is taken at room temperature and 150° C. As a result, all the vibrational stretches are from permethrin contribution. The purpose of this experiment was to determine the stability of permethrin at high temperatures. A temperature of 150° C. was chosen because it is well above the temperature limit for using the proposed product for any practical purpose. As seen in the spectra, the peaks indicative of permethrin bands persist at this temperature. This indicates that permethrin is thermally stable and the detergent does not have any catalytic effect on permethrin even at higher temperatures up to 150° C. The negative band seen at 3500 cm⁻¹ after heating at 150° C. indicates that evaporation and desorption of physisorbed water from the surface of the detergent was the only result of heating.

Based on these results, it was concluded that permethrin remains in its active form upon loading in detergent. No degradation was observed on the molecular structure of permethrin even after exposure to harsh operating conditions.

Additional embodiments of the invention include concentrates to be added to conventional laundry detergents. Such concentrates could be marketed in soluble packets for addition to laundry prior to washing, much as bleach or the like is conventionally added. Alternatively, the permethrin composition could be incorporated into a solid fabric softener, as described in U.S. Pat. No. 9,150,819, issued to Wetrosky et al, fully incorporated herein. A concentrate of permethrin could further include products selected from the group consisting of bleach, fabric softeners, starch, perfumes, and laundry additives.

Another embodiment contemplated by applicant includes incorporating a permethrin concentrated solution in microcapsules to achieve a sustained release of insect repellant substances. Such microcapsules are well known, and described in U.S. Pat. No. 8,460,792, to Smets et al, fully incorporated herein. The microcapsules could be premixed with either a solid or liquid laundry detergent, or provided as a laundry additive to be added during the wash cycle.

### Experimental

### Sample Preparation

Two pieces of white cotton clothes were used for this experiment because of their transparency to infrared light. White pieces of 13 other materials were also used. The first piece of cloth was washed with off the shelf detergent, containing no permethrin, and the second piece was washed with detergent according to the invention loaded with permethrin. The two samples were then rinsed with lab grade de-ionized water with a purity of 18.2 MΩ. The samples were then dried in an oven at 110° C. for 20 minutes.

### Infrared Spectroscopic Analysis

The dried samples of cloth were each loaded in a transmission infrared spectroscopic cell and spectra were collected using 64 scans. The cloth without permethrin was first measured as a control. The cloth washed with detergent according to the invention was then measured and the individual —C═C— and —C—O—C— vibrational stretching from permethrin were monitored. Infrared spectra of the cloth washed with permethrin were taken over a fourteen-day period for the first test and 12 days for the subsequent tests in order to elucidate the kinetics of permethrin depletion.

### 2. Results and Discussion

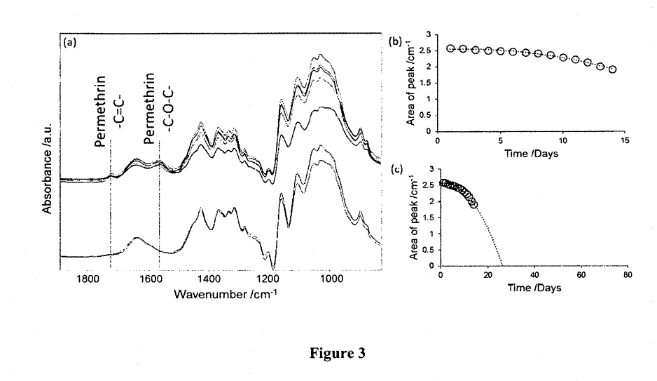

FIG. 3 (a) represents the infrared spectra of a cotton cloth sample washed with off the shelf detergent (bottom) and a cloth sample washed with detergent according to the invention (top). The first sample was used as a control and only the second sample including detergent according to the invention was used for the analysis. The peaks at 1720 and 1570 cm⁻¹ represents vibrational stretches of —C═C— and —C—O—C— respectively which is indicative of the presence of permethrin. The integrated area of the peaks at 1570 cm⁻¹ was plotted against the time of the experiment in order to determine the lifespan of permethrin on the cloth. FIG. 3 (b) shows a 2^{nd} order polynomial relationship of permethrin depletion over time during a 14 day period. The data was extrapolated to determine the lifespan of permethrin on cloth after treatment with detergent according to the invention. The extrapolation as seen in FIG. 3 (c) indicates that permethrin is active on the cloth over approximately 27 days. Similarly, the lifespan of permethrin in different cloth materials is seen in Table 1 below.

TABLE 1

| Material | Lifespan of Permethrin (Days) |
|---|---|
| 100% Cotton Plain | 25 |
| 100% Polyester Net | >18 |
| 65% Polyester 35% Cotton | >18 |
| 100% Polyester Silk | >22 |
| 100% Cotton Jeans | 18 |
| 65% Polyester 35% Rayon | >19 |
| 80% Polyester 20% Spandex | 19 |
| 45% Polyester 55% Cotton | 21 |
| 55% Linen 45% Cotton | >22 |
| 40% Polyester 60% Cotton | 19 |
| 100% Polyester wool | >14 |
| 59% Cotton 41% Acrylic Wool | >16 |
| 100% Cotton Towel | >15 |

### CONCLUSION

Detergent according to the invention is effective for transferring an active insect repellant on clothes. Physicochemical characterization indicates that the ingredient is active on the cloth for greater than 2 weeks and up to 27 days depending on the clothing material.

### SUMMARY

IR Spectra were taken everyday for 14 days to determine the amount of active Permethrin on cloth.
Polynomial trend in an order of 2 was observed when the data was fitted.
Data was extrapolated after 14 days to determine how long Permethrin will last on cloth.
Extrapolation indicates that Permethrin will last for approximately 27 days.

1. A laundry detergent for cleaning fabric such that the fabric immediately becomes insect repellent and kills insects on contact for at least 14 days comprising a liquid laundry detergent and a liquid permethrin solution wherein the laundry detergent comprises 0.21 ounce of 36.8% permethrin concentrate per 1 gallon of detergent.

2. The laundry detergent for cleaning fabric of claim 1 further including products selected from the group consisting of bleach, fabric softeners, starch, odorants, and laundry additives.

3. The laundry detergent of claim 1 further including an additive selected from the group consisting of oil of lemon, oil of citronella, and oil of eucalyptus.

4. (canceled)

5. The method of making a permethrin laundry detergent composition comprising mixing 0.21 ounce of 36.8% permethrin concentrate per 1 gallon of water, to make a permethrin water solution, and impregnating a dry laundry detergent support having a pore volume of 0.26 ml/g with the permethrin water solution using capillary action, and drying the composition under reduced pressure.

6. A method of making a dry laundry detergent which repels and kills insects on contact for at least 14 days, including permethrin, comprising determining the pore volume of a dry detergent support using nitrogen physisorption followed by bet calculations then mixing 0.21 ounce of 36.8% permethrin concentrate with 2 ounces of liquid laundry detergent and 1 gallon of water, and adding the permethrin/liquid laundry detergent/water solution to the dry detergent support in an amount equal to the pore volume of the dry detergent support, wherein a fabric washed with the dry laundry detergent repels and kills insects that contact the fabric.
